(19) United States
(12) Patent Application Publication
(10) Pub. No.: US 2016/0028890 A1
(43) Pub. Date: Jan. 28, 2016

(54) INFORMATION PROCESSING APPARATUS, RECORDING MEDIUM, AND INFORMATION PROCESSING METHOD

(71) Applicant: FUJI XEROX CO., LTD., Tokyo (JP)

(72) Inventors: Hiroki SUGIBUCHI, Yokohama-shi (JP); Hiroshi UMEMOTO, Yokohama-shi (JP); Motoyuki TAKAAI, Yokohama-shi (JP)

(21) Appl. No.: 14/877,555

(22) Filed: Oct. 7, 2015

Related U.S. Application Data
(63) Continuation of application No. PCT/JP2014/053803, filed on Feb. 18, 2014.

(30) Foreign Application Priority Data
Aug. 23, 2013 (JP) 2013-173289

(51) Int. Cl. H04M 3/51; H04M 3/523

(52) U.S. Cl. CPC H04M 3/5175; H04M 3/5233

(57) ABSTRACT

In order to provide an information processing apparatus that estimates a receptionist's specialty in the case where a question from a questioner is answered by the receptionist, a first calculation unit of the information processing apparatus calculates an amount of information on an answer, which is an amount of information on a receptionist's answer to a question from a questioner, a second calculation unit calculates an amount of acquired information, which is an amount of information acquired by the receptionist to make the answer, and an estimation unit estimates the receptionist's specialty in accordance with the amount of information on the answer and the amount of acquired information.

### CROSS REFERENCE TO RELATED APPLICATION

This is a continuation of International Application No. PCT/JP2014/053803 filed on Feb. 18, 2014, and claims priority from Japanese Patent Application No. 2013-173289, filed on Aug. 23, 2013.

### TECHNICAL FIELD

The present invention relates to an information processing apparatus, a recording medium, and an information processing method.

### SUMMARY OF INVENTION

According to an aspect of the invention, there is provided an information processing apparatus including a first calculation unit that calculates an amount of information on an answer, which is an amount of information on a receptionist's answer to a question from a questioner, a second calculation unit that calculates an amount of acquired information, which is an amount of information acquired by the receptionist to make the answer, and an estimation unit that estimates the receptionist's specialty in accordance with the amount of information on the answer and the amount of acquired information.

### BRIEF DESCRIPTION OF DRAWINGS

FIG. 1 is a schematic module configuration diagram of an example of a configuration of a present exemplary embodiment.

FIG. 2 is an illustrative diagram illustrating an example of a system configuration for realizing the present exemplary embodiment.

FIG. 3 is an illustrative diagram illustrating an example of correspondence between a questioner, an operator, and other operators.

FIG. 4 is an illustrative diagram illustrating an example of the amount of information in correspondence between a questioner, an operator, and other operators.

FIG. 5 is a flowchart illustrating an example of a process according to the present exemplary embodiment.

FIG. 6 is a flowchart illustrating an example of a process according to the present exemplary embodiment.

FIG. 7 is a flowchart illustrating an example of a process according to the present exemplary embodiment.

FIG. 8 is an illustrative diagram illustrating an example of the amounts and directions of information on specialty in an initial stage, a middle stage, and a last stage.

FIG. 9 is an illustrative diagram illustrating examples of a threshold for determining specialty.

FIG. 10 is an illustrative diagram illustrating an example of a data structure of an operator management table.

FIG. 11 is a block diagram illustrating an example of a hardware configuration of a computer that realizes a present exemplary embodiment.

### REFERENCE SIGNS LIST

100 . . . information processing apparatus
110 . . . message receiving module
120 . . . message analysis module
130 . . . amount-of-information calculation module
140 . . . language processing module
150 . . . specialty estimation module
160 . . . difficulty-level estimation module
170 . . . assignment module

### DETAILED DESCRIPTION

In the following, an example of a preferable exemplary embodiment for realizing the present invention will be explained in accordance with the drawings.

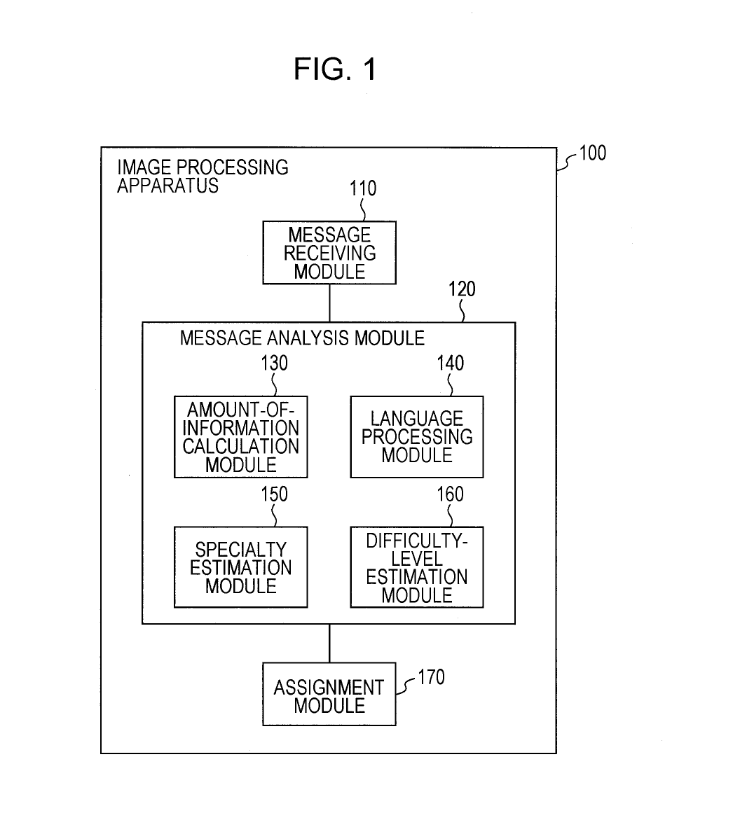

FIG. 1 illustrates a schematic module configuration diagram of an example of a configuration of the present exemplary embodiment.

Note that modules generally refer to parts that are logically separable such as software (computer programs), hardware, and the like. Thus, modules in the present exemplary embodiment refer to not only modules in a computer program but also modules in a hardware configuration. Thus, the present exemplary embodiment also explains computer programs that function as these modules (a program for causing a computer to execute each procedure, a program for causing a computer to function as each unit, and a program for causing a computer to realize each function), a system, and a method. Note that, for convenience's sake in terms of explanation, “store”, “cause . . . to store” and expressions similar to these are used. These expressions mean that, in the case where an exemplary embodiment is a computer program, a storage device is caused to store . . . or control is performed such that a storage device is caused to store . . . . There may be a one-to-one correspondence between modules and functions. When modules are mounted, one module may be configured by one program or plural modules may be configured by one program. Alternatively, one module may be configured by plural programs. Moreover, plural modules may be executed by one computer or one module may be executed by plural computers, which are computers in a distributed environment or a parallel processing environment. Note that one module may include another module. In addition, in the following, “connection” may be used not only for a physical connection but also for a logical connection (transmitting-receiving of data, instructions, a reference relationship between data, and the like). “Predetermined” means something is determined before a target process is performed, and also means that something is determined not only before a process according to the present exemplary embodiment starts but also after the process according to the present exemplary embodiment starts and before a target process starts, depending on a status or a state at that point in time or in accordance with a status or a state until that point in time. In the case where there are plural “predetermined values”, the predetermined values may differ from one another or two or more of the predetermined values (as a matter of course, including all the predetermined values) may be the same. In addition, a description meaning “in the case of A, B is performed” is used to mean that “It is determined whether or not . . . is A. In the case where it is determined that . . . is A, B is performed”. Note that cases where a determination as to whether or not . . . is A is unnecessary are excluded.

In addition, a system or an apparatus may not only be configured by plural computers, hardware devices, apparatuses, and the like connected by communication means such as a network (including one-to-one correspondence communication connection) but also be realized by one computer, a hardware device, an apparatus, or the like. An “apparatus” and a “system” are used as words having the same meaning. As a matter of course, the “system” does not include just a social “mechanism” (a social system), which is man-made arrangements.

For each process performed by each module or for each process in the case where plural processes are performed in a module, target information is read from a storage device. After the process is performed, a processing result is written into the storage device. Thus, an explanation may be omitted for reading target information from the storage device before a process is performed and an explanation may be omitted for writing target information into the storage device after a process is performed. Note that here a storage device may include a hard disk, a random access memory (RAM), an external storage medium, a storage device connected through a communication line, a register in a central processing unit (CPU), and the like.

An information processing apparatus 100 according to a present exemplary embodiment is an apparatus that estimates a receptionist's specialty (a receptionist also being referred to as an operator), the receptionist answering a question from a questioner, and includes, as illustrated in an example of FIG. 1, a message receiving module 110, a message analysis module 120, and an assignment module 170. Examples of a situation where the present exemplary embodiment is used include a call center, a consulting center, and the like where a question from a questioner such as a customer, a client, or the like is answered. Note that questions include not only for raising of a question or demanding of a reason but also consultations for asking opinions from a receptionist or the like.

The message receiving module 110 is connected to the message analysis module 120. The message receiving module 110 receives a message in communication performed between a questioner and a receptionist. Communication includes wireless communication, wired communication, and a combination of wireless and wired communication. Communication targets include data communication and voice communication by phone or the like. For example, a message may be extracted from an e-mail, a chat, or a social networking service (SNS). Alternatively, voice may be extracted from voice communication, voice recognition may be performed, and text data may be generated as a message. The direction of communication should be determined in accordance with a transmission source (the from section in the case of an e-mail) and a destination (the to section in the case of an e-mail).

Note that a “questioner” has only to be a person who addresses a question to a receptionist A. Examples of the “questioner” include a receptionist B, who is another receptionist, in addition to a user who is a questioner who addresses a fundamental question (the first question serving as an inspiration). An example of the case where the receptionist B, who is the other receptionist, is a questioner, is the case where the receptionist B addresses a question to the receptionist A in order to deal with the user's fundamental question. Note that, generally, the “receptionist A” is a person regarded by the receptionist B as “a person who has more professional knowledge than me (the receptionist B) about a question addressed to me (the receptionist B)”.

Thus, as combinations for communication, there are two types: a receptionist and a user serving as a questioner; and a receptionist and another receptionist serving as a questioner. The content of communication performed between a questioner and a receptionist is a question and an answer to the question. In particular, communication performed between a receptionist and another receptionist serving as a questioner is a question addressed to the receptionist, who is not the other receptionist, and an answer to the question in order to answer a question from a user.

The message analysis module 120 is connected to the message receiving module 110 and the assignment module 170, and includes an amount-of-information calculation module 130, a language processing module 140, a specialty estimation module 150, and a difficulty-level estimation module 160.

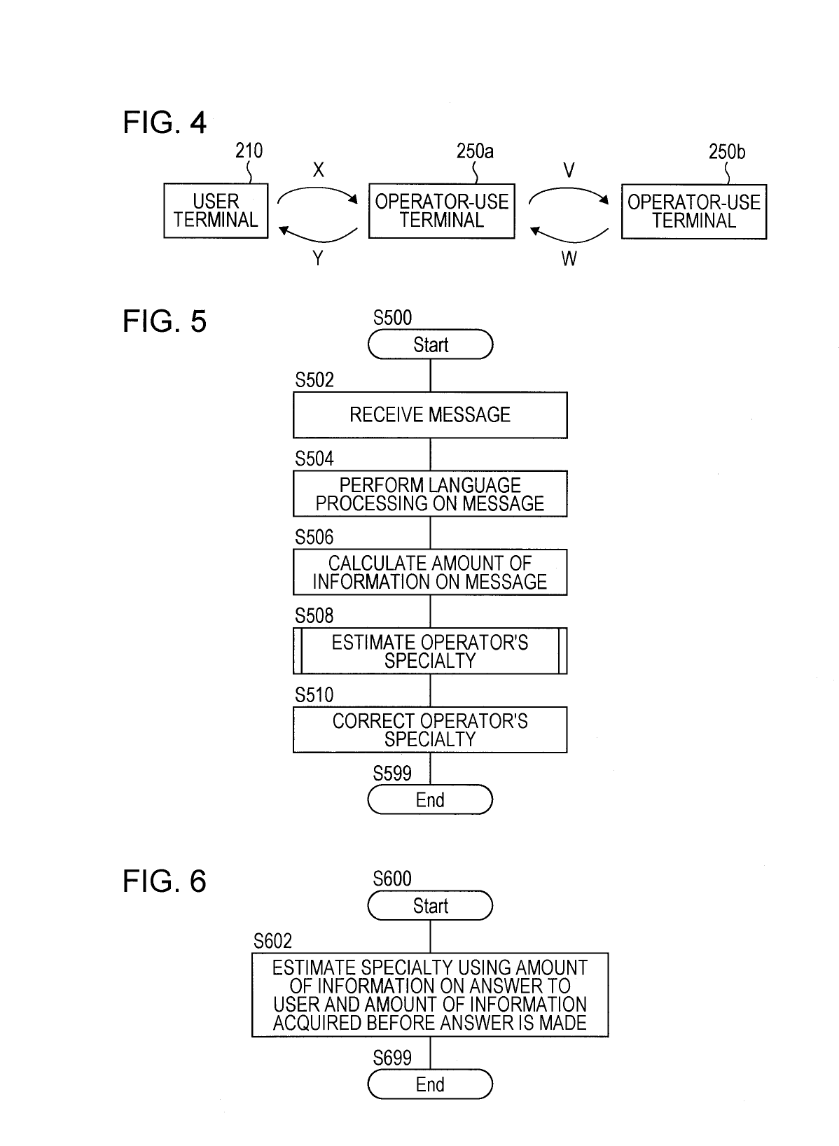

The amount-of-information calculation module 130 calculates the amount of information on an answer, which is the amount of information on a receptionist's answer to a question from a questioner. For example, the amount of information on an answer refers to Y in FIG. 4, which will be described later. Then, the amount of acquired information is calculated, which is the amount of information acquired by the receptionist so as to make the answer. “Calculation of the amount of information” may be, in addition to measurement of the amount of text (the number of bytes or the like) of a message received by the message receiving module 110, measurement of the duration of a call by phone (the duration of an actual conversation obtained by removing a silent portion from the duration of a call may also be measured), extraction of the number of topics (the number of fields) brought up in the message, or the like. The number of topics (the number of fields) brought up in a message refers not only simply to the number of sentences or the number of paragraphs but also to, for example, the number of sets of pieces of content, each set having targets in common as a topic (a procedure, processing content, contact information, a department that should perform handling, or the like). As a method for extracting the number of topics, the following will be performed. Data are prepared in which messages in the past are associated with topics of the messages, and machine learning is performed using the data obtained by performing association as training data. As machine learning, for example, a support vector machine (SVM) or the like is used. Then, topics corresponding to a target message are assumed using a determination machine that has performed machine learning, and the number of topics may be treated as the amount of information.

In addition, the amount-of-information calculation module 130 may also calculate the amount of acquired information such that information acquired by a receptionist includes an answer to a question addressed to another receptionist. The amount of information on “an answer to a question addressed to another receptionist” includes, for example, at least W in FIG. 4, which will be described later.

Furthermore, the amount-of-information calculation module 130 may also calculate the amount of acquired information such that the information acquired by the receptionist includes either one of or both of a question from a questioner and a question addressed to the other receptionist. The amount of information on “a question from a questioner” refers to, for example, X in FIG. 4, which will be described later. The amount of information on “a question addressed to the other receptionist” refers to, for example, V in FIG. 4, which will be described later.

The language processing module 140 analyzes a message received by the message receiving module 110 and determines the type of the message. The types of messages are, for example, question, request, consultation, confirmation, and the like. As an analysis method, data are prepared in which messages in the past are associated with types of message, and machine learning is performed using the data as training data. Then, a type corresponding to a target message should be determined using a determination machine that has performed the machine learning. The types of message may also be determined by combining morphological analysis, syntactic analysis, and the like using dictionaries or using “wording” analysis indicating, for each type, words and the like that are often used.

The specialty estimation module 150 estimates a receptionist's specialty in accordance with the amount of information on an answer and the amount of acquired information calculated by the amount-of-information calculation module 130. “In accordance with the amount of information on an answer and the amount of acquired information” has only to refer to something indicating a relationship between the amount of information on the answer and the amount of acquired information. For example, “in accordance with the amount of information on an answer and the amount of acquired information” may refer to calculation of the difference between the amount of information on the answer and the amount of acquired information, may also refer to calculation of the ratio between the amount of information on the answer and the amount of acquired information, or may also refer to calculation of the ratio between the amount of information on the answer and (the amount of information on the answer+the amount of acquired information). Then, the concerned specialty may be determined by comparing a calculation result (the difference, the ratios, or the like) with a certain threshold, which is a predetermined value. The specialty has at least two levels (for example, high specialty, no specialty, and the like) and may also have three levels or more. As a matter of course, in the case of two levels, one threshold is used, and in the case of three levels or more, two thresholds or more are used. In addition, for each topic of a question, the specialty may also be estimated. As a result of estimation of specialty, for example, an operator management table 1000 is generated. FIG. 10 is an illustrative diagram illustrating an example of a data structure of the operator management table 1000. The operator management table 1000 includes an operator ID section 1010, a topic section 1020, and a specialty section 1030. The operator ID section 1010 stores information used to uniquely identify an operator in the present exemplary embodiment (an operator ID: IDentification). The topic section 1020 stores a topic. The specialty section 1030 stores the operator's specialty for the topic. Note that the operator management table 1000 may only include the operator ID section 1010 and the specialty section 1030.

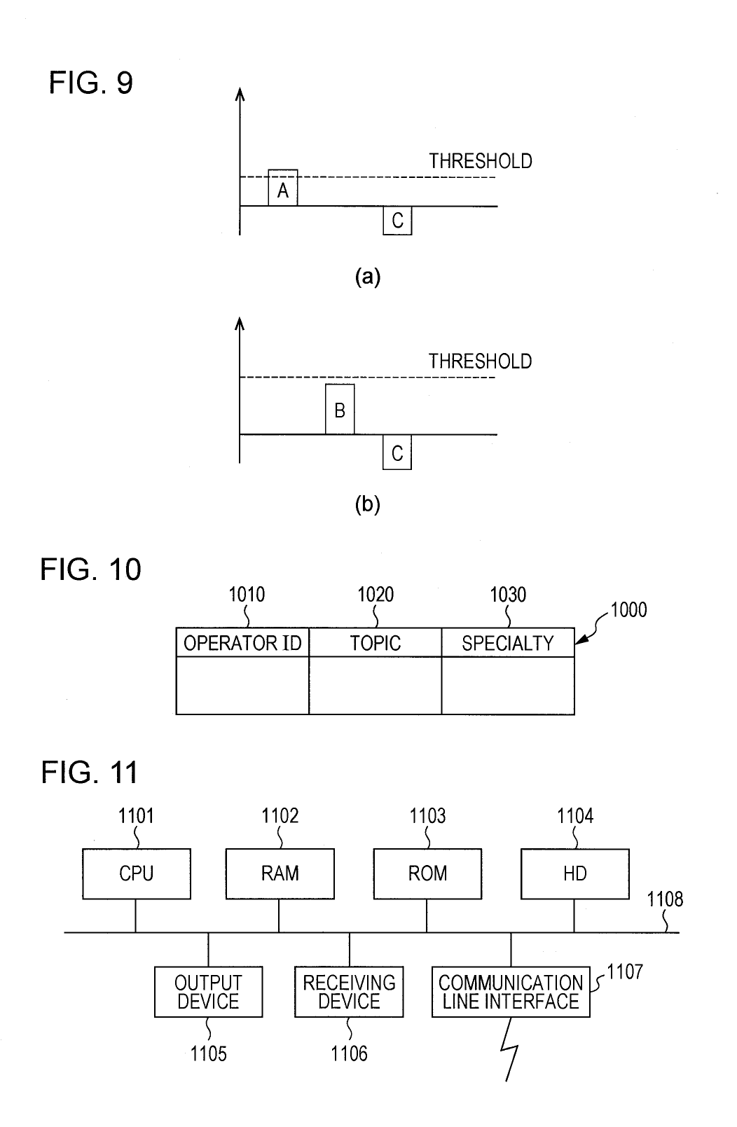

Alternatively, the specialty estimation module 150 may also estimate the receptionist's specialty further in accordance with a difficulty level estimated by the difficulty-level estimation module 160. Details will be described using an example of FIG. 9.

The difficulty-level estimation module 160 estimates the difficulty level of a question in accordance with the total amount of information needed to answer the question, which has been received by the message receiving module 110. The total amount of information refers to, for example, (X+V+W) in FIG. 4, which will be described later. For a difficulty level, there are at least two levels (for example, a high difficulty level, a low difficulty level, and the like) and there may also be three levels or more. As a matter of course, in the case of two levels, one threshold is used, and in the case of three levels or more, two thresholds or more are used.

The assignment module 170 is connected to the message analysis module 120. The assignment module 170 assigns a receptionist to a question, the receptionist dealing with the question, in accordance with the specialty estimated by the specialty estimation module 150. The operator management table 1000 may be used in this assignment. For example, a topic of a message (a question) is assumed, and an operator whose specialty is highest among currently available operators may be assigned using the operator management table 1000. Alternatively, the difficulty level of a message (a question) is estimated, and an operator having specialty to deal with the difficulty level may be assigned. Here, the difficulty level may also by estimated using the amount of information on the message (the question). As described above, data are prepared in which messages in the past are associated with the difficulty levels of the messages, and machine learning is performed using the data as training data. Then, the difficulty level corresponding to a target message should be determined using a determination machine that has performed the machine learning.

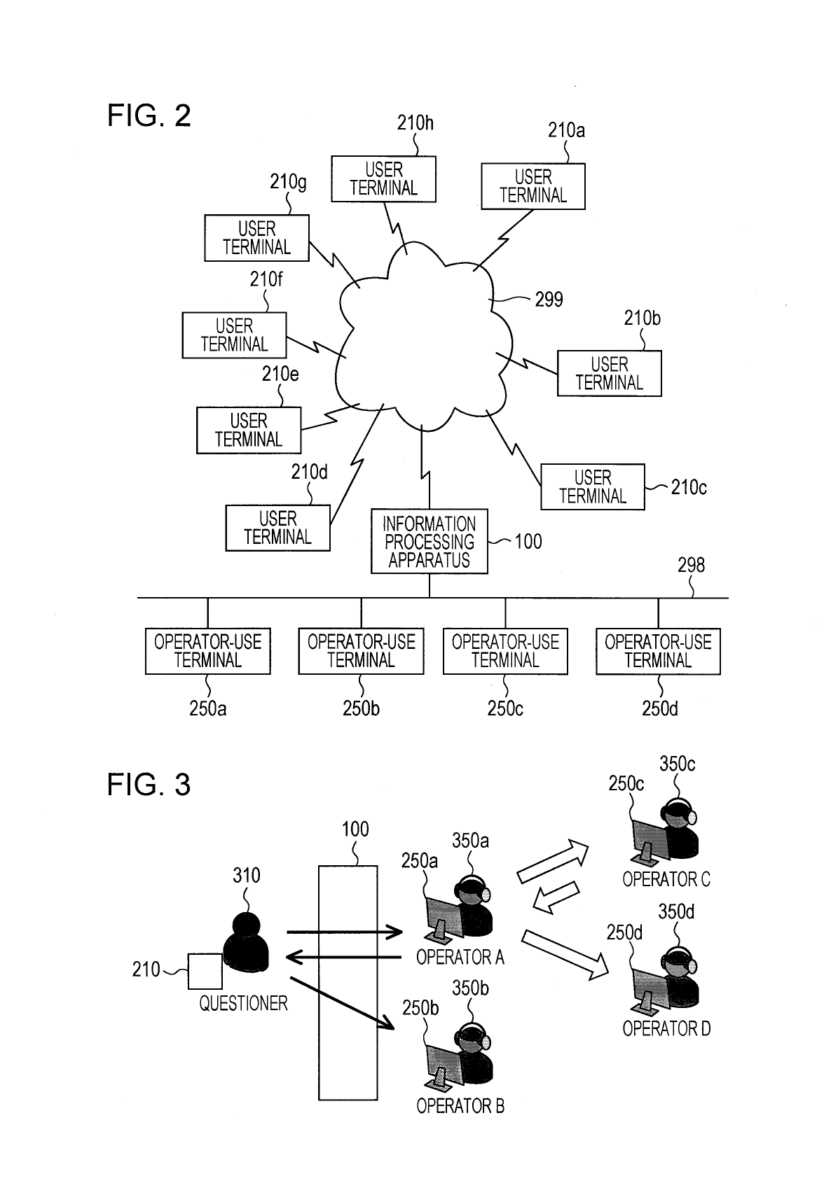

FIG. 2 is an illustrative diagram illustrating an example of a system configuration for realizing the present exemplary embodiment.

User terminals 210a to 210h are connected to the information processing apparatus 100 via communication lines 299. Then, the information processing apparatus 100 is connected to operator-use terminals 250a to 250d via communication lines 298. In addition, operator-use terminals 250 are connected to each other via the communication lines 298.

Thus, the information processing apparatus 100 may acquire communication between user terminals 210 and the operator-use terminals 250 and communication between two operator-use terminals 250.

FIG. 3 is an illustrative diagram illustrating an example of correspondence between a questioner, an operator, and other operators.

The length of an arrow represents the amount of information. A long arrow represents a large amount of information and a short arrow represents a small amount of information. Note that, as described above, the information processing apparatus 100 also acquires messages from communication between the operator-use terminal 250a and the operator-use terminal 250c and communication between the operator-use terminal 250a and the operator-use terminal 250d, in addition to communication between the information processing apparatus 100 and the operator-use terminal 250a and communication between the information processing apparatus 100 and the operator-use terminal 250b.

A questioner 310 operates a user terminal 210, an operator A: 350a operates the operator-use terminal 250a, an operator B: 350b operates the operator-use terminal 250b, an operator C: 350c operates the operator-use terminal 250c, and an operator D: 350d operates the operator-use terminal 250d.

The user terminal 210 transmits a message of a question in accordance with an operation of the questioner 310.

The information processing apparatus 100 transmits the message of the question to the operator A: 350a (the operator-use terminal 250a) in accordance with operators' specialty. Note that “the operator A: 350a (the operator-use terminal 250a)” indicates the operator-use terminal 250a operated by the operator A: 350a (likewise in the following). For example, in the case where communication is performed using e-mail, the message is transmitted to an e-mail address of the operator A: 350a.

The operator A: 350a transmits, in order to acquire information on answering the question, a message of a question or the like to the operator C: 350c (the operator-use terminal 250c) and the operator D: 350d (the operator-use terminal 250d).

Then, the operator C: 350c (the operator-use terminal 250c) transmits a message of an answer or the like to the operator A: 350a (the operator-use terminal 250a).

Lastly, the operator A: 350a (the operator-use terminal 250a) transmits an answer sentence corresponding to a question sentence to the questioner 310 (the user terminal 210).

A question asked by a questioner is distributed to an appropriate operator after the topic of the question is assumed and the difficulty level and the like of the question are estimated from the content of the question. An operator inquires of another operator or the like about information (knowledge) for an answer, or, on the contrary, receives an inquiry made by another operator. For an operator who has acquired a lot of information from a questioner or other operators, the operator's specialty is evaluated as low specialty. In contrast, for an operator who has supplied a lot of information to a questioner or other operators, the operator's specialty is evaluated as high specialty.

FIG. 4 is an illustrative diagram illustrating an example of the amount of information in correspondence between a questioner, an operator, and other operators. FIG. 4 is a diagram obtained by schematically illustrating what is illustrated in the example of FIG. 3, in terms of the direction of information and the amount of information.

X represents the amount of information on a message (a question) from the user terminal 210 to the operator-use terminal 250a.

Y represents the amount of information on a message (an answer) from the operator-use terminal 250a to the user terminal 210.

V represents the amount of information on a message (a question and the like) from the operator-use terminal 250a to the operator-use terminal 250b. Here, the question and the like include, in addition to a question, a request, a consultation, a confirmation, and the like.

W represents the amount of information on a message (an answer and the like) from the operator-use terminal 250b to the operator-use terminal 250a.

The amount of information on the answer described above refers to V in the example of FIG. 4. In addition, the amount of acquired information includes at least W in the example of FIG. 4, and may also include either one of or both of X and V. Thus, the amount of acquired information is either one of (W), (W+X), (W+V), and (W+X+V). In addition, for each amount of information, in the case where communication is performed plural times, the amount of information is the sum of the amounts of information on the communications.

FIG. 5 is a flowchart illustrating an example of a process according to the present exemplary embodiment.

In step S502, the message receiving module 110 receives a message from the user terminal 210.

In step S504, the language processing module 140 performs language processing on the message and determines the type of the message. In the case where it is determined that the content of the message is a question transmitted from the user terminal 210, a process as in the following is performed. The topic of the message (the question) is assumed. An operator is determined, using the operator management table 1000, to whom the message (the question) from the user terminal 210 is distributed, and the message (the question) is distributed to the operator. In addition, furthermore, the difficulty level of the message is estimated, and the message may be distributed to an operator having specialty to deal with the difficulty level.

In step S506, the amount-of-information calculation module 130 calculates the amount of information on the message. Until communication is performed from the operator-use terminal 250a to the user terminal 210, the communication being an answer to the question transmitted from the user terminal 210, processing in steps S502 to S506 may be repeatedly performed. Lastly, X, Y, V, and W illustrated in the example of FIG. 4 are calculated.

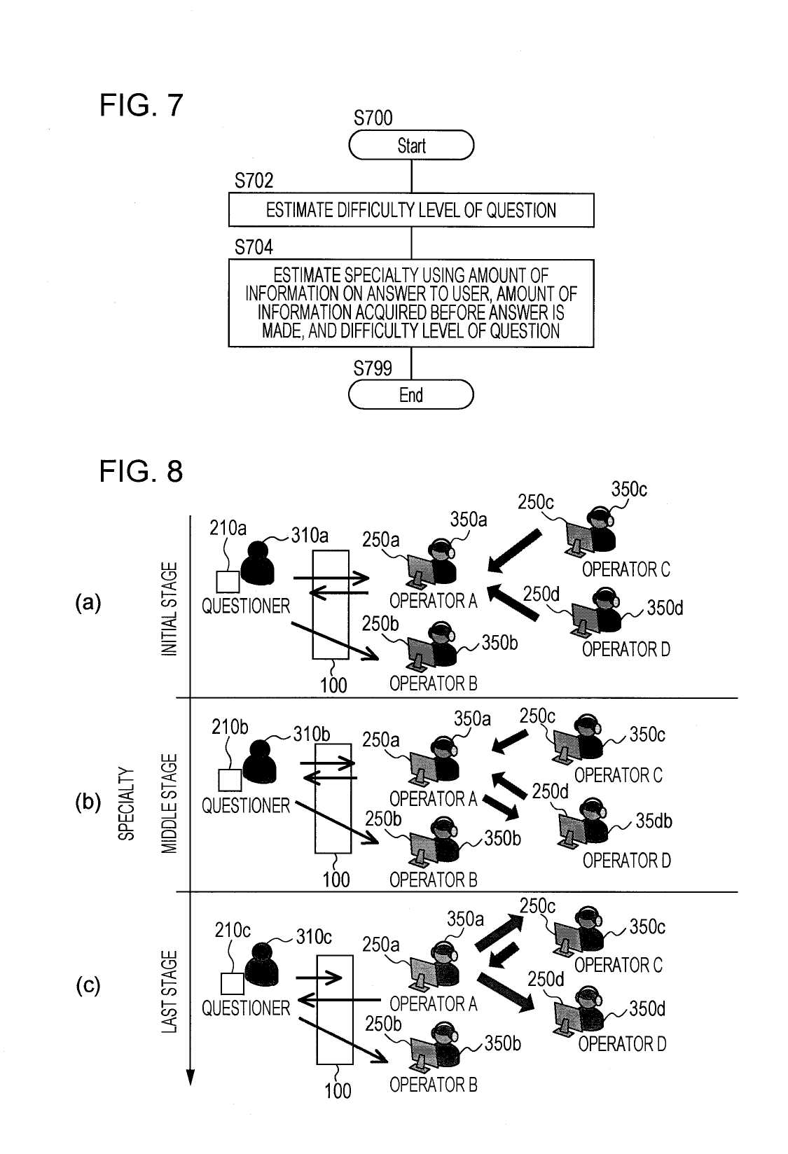

In step S508, the specialty estimation module 150 estimates the operator's specialty. Processing in step S508 will be described later using flowcharts illustrated in examples of FIG. 6 and FIG. 7.

In step S510, the specialty estimation module 150 corrects the operator's specialty. Specifically, the concerned specialty in the operator management table 1000 is corrected.

FIG. 6 is a flowchart illustrating an example of a process according to the present exemplary embodiment.

In step S602, the specialty estimation module 150 estimates specialty using the amount of information on an answer to the user and the amount of information acquired before the answer is made. When an explanation is made using the example of FIG. 4, the specialty is estimated using values of (Y−W), (Y−(W+X)), (Y−(W+V)), (Y−(W+X+V)), (Y/W), (Y/(W+X)), (Y/(W+V)), (Y/(w+X+V)), (Y/(Y+W)), (Y/(Y+W+X)), (Y/(Y+W+V)), and (Y/(Y+W+X+V)).

FIG. 7 is a flowchart illustrating an example of a process according to the present exemplary embodiment.

In step S702, the difficulty-level estimation module 160 estimates the difficulty level of the question.

In step S704, the specialty estimation module 150 estimates specialty using the amount of information on an answer to the user, the amount of information acquired before the answer is made, and the difficulty level of the question. Step S704 is a step in which the difficulty level of the question is added in step S602 of FIG. 6 and then specialty is estimated.

FIG. 8 is an illustrative diagram illustrating an example of the amounts and directions of information on specialty in an initial stage (part (a) of FIG. 8), a middle stage (part (b) of FIG. 8), and a last stage (part (c) of FIG. 8).

In the case where the type of a message is determined from the content of the message, language processing is used. For example, in the case where the operator A collects information from the operators C and D, who are other operators, it is assumed that changes occur in the content of an e-mail as in the following.

The initial stage: for making an answer, the operator A acquires a lot of information from other operators (including professionals) and then makes an answer to the questioner. Here, the operator is unable to efficiently collect information from the questioner and ends up acquiring a lot of information by acquiring information related to necessary information.

The middle stage: for making an answer, although the operator A collects information from other operators as necessary, it comes about that the frequency of information collection is reduced. In addition, it comes about that changes occur in the content of information collection such that confirmation is performed more often. Furthermore, it comes about that information is efficiently collected from the questioner.

The last stage: the operator A becomes able to return a lot of content with a minimum number of confirmations to the questioner. In addition, the operator A answers questions asked by other operators or offers a consultation more frequently, and outputs the larger amount of information.

In the example of FIG. 8, as illustrated by the directions and lengths (the amounts of information) of arrows, the operator A acquires a lot of information from the questioner and then makes an answer in the initial stage. The operator A acquires a lot of information from the operators C and D, but the amount of information provided to the operator C and D is none. The less amount of information is acquired from the questioner in the middle stage than in the initial stage. The less amount of information is also acquired from the operators C and D, and there is the amount of information provided to the operator D. Furthermore, the less amount of information is acquired from the questioner in the last stage than in the middle stage. The amount of information on an answer to the questioner is increased. Furthermore, the less amount of information is acquired from the operators C and D (the amount of information acquired from the operator D is 0). The amount of information provided to the operators C and D is larger than the amount of information acquired from the operators C and D. That is, the last stage is a state in which the operator A offers consultations to other operators.

Specifically, the type of message changes as in the following.

(Initial Stage): the amount of acquired information is larger than the amount of information on an answer.
“What should I answer to the question asked by Xxx?”

### (Consultation)

↓
(Middle Stage): the amount of information on an answer balances the amount of acquired information.
“Xxx has asked a question. Where in the document should I refer to?”

### (Question)

↓
(Last Stage): the amount of acquired information is smaller than the amount of information on an answer.
“Xxx has asked a question. There isn't any problem in that the answer is ΔΔΔ, is there?” (Confirmation)

The specialty estimation module 150 may also estimate specialty using this and using the type of message. For example, specialty is estimated on the basis of what is most frequently performed among consultations, questions, and confirmations. Specifically, if consultations are frequently performed, specialty is determined to be low. If questions are frequently performed, specialty is determined to be intermediate. If confirmations are frequently performed, specialty is determined to be high.

FIG. 9 is an illustrative diagram illustrating examples of a threshold for determining specialty.

The vertical axis represents “the amount of information on an answer−the amount of acquired information”. The horizontal axis represents operator.

Part (a) of FIG. 9 illustrates a threshold in the case of a high difficulty level. Since, for the operator A, “the amount of information on an answer−the amount of acquired information” is greater than or equal to the threshold, it is estimated that the operator A's specialty is high. Part (b) of FIG. 9 illustrates a threshold in the case of a low difficulty level (which is a threshold higher than the threshold illustrated in the example of part (a) of FIG. 9). Although the operator B has “the amount of information on an answer −the amount of acquired information” higher than that of the operator A, the answer has been made for a question the difficulty level of which is low. Thus, it is estimated that the operator B's specialty is not high. Note that, for the operator C, “the amount of information on an answer−the amount of acquired information” is lower than the threshold, and thus it is estimated that the operator C's specialty is not high.

There may be the case where an operator's specialty is not correctly evaluated since, even when the topics are the same, the more amount of information is needed in the case where answers are made for many questions the difficulty level of which is high. Thus, the threshold for determination is changed to another in accordance with a difficulty level so that correct evaluation is performed. This threshold may be regarded as a statistical value (the average, a mode, a median, or the like) for the amount of information necessary to make an answer, and is estimated from the amount of information necessary for a question asked in the past and similar to the question for the answer.

Note that a hardware configuration of a computer by which a program serving as a present exemplary embodiment is executed is, as illustrated in FIG. 11, that of a general computer and is specifically that of a personal computer, a computer that could be a server, or the like. That is, as a specific example, a CPU 1101 is used as a processing unit (an arithmetic unit), and a RAM 1102, a ROM 1103, and a HD 1104 are used as a storage device. As the HD 1104, for example, a hard disk may also be used. The computer includes the CPU 1101, the RAM 1102, the ROM 1103, the HD 1104, an output device 1105, a receiving device 1106, a communication line interface 1107, and a bus 1108. The CPU 1101 executes programs such as the message receiving module 110, the amount-of-information calculation module 130, the language processing module 140, the specialty estimation module 150, the difficulty-level estimation module 160, the assignment module 170, and the like. The programs and data are stored in the RAM 1102. Programs and the like for starting up the computer are stored in the ROM 1103. The HD 1104 is an auxiliary storage device (may also be a flash memory or the like). The receiving device 1106 receives data in accordance with a user's operation through a keyboard, a mouse, a touch panel, or the like. The output device 1105 is a CRT, a liquid crystal display, or the like. The communication line interface 1107 is an interface for connection to a communication network, such as a network interface card or the like. The bus 1108 connects the CPU 1101, the RAM 1102, the ROM 1103, the HD 1104, the image output device 1105, the receiving device 1106, and the communication line interface 1107 to each other and is a bus for data exchange. Plural such computers may be connected to each other through a network.

One of the above-described present exemplary embodiments, which is about the computer program, is realized by causing a system having the hardware configuration to read the computer program, which is software, and causing software and hardware resources to cooperate.

Note that the hardware configuration illustrated in FIG. 11 is an exemplary configuration. The present exemplary embodiment is not limited to the configuration illustrated in FIG. 11, and has only to have a configuration that may execute the modules explained in the present exemplary embodiment. For example, some of the modules may be configured using a dedicated hardware device (for example, an ASIC or the like). Some of the modules may be provided in an external system and connected through communication lines. Furthermore, plural such systems illustrated in FIG. 11 may be connected to each other through communication lines and may operate in a cooperation manner. In addition, in particular, the modules may be installed not only in a personal computer but also in a home information appliance, a copier, a facsimile, a scanner, a printer, a multifunction machine (an image processing apparatus having any two or more functions of a scanner, a printer, a copier, a facsimile, and the like), and the like.

Note that, in the above-described example, one question is asked and one answer is made in the correspondence between the operator and the questioner; however, the operator may also make an answer after acquiring information necessary for the answer through correspondence with the questioner in order to clarify the question. Such correspondence may be performed plural times. In this case, the amount of acquired information may include the amount of information acquired from the correspondence with the questioner. As a matter of course, the amount of information on the answer from the operator to the questioner (the last message from the operator to the questioner) is the amount of information on the answer and is not included in the amount of acquired information. Note that whether or not a message from an operator to a questioner is an answer may be determined by the language processing module 140 from the context of the message. Alternatively, the language processing module 140 may determine that, in the case where no communication is performed between the operator and the questioner for a predetermined period after target communication is completed, the communication is an answer.

Note that the program that has been explained may also be stored in a recording medium and provided. Furthermore, the program may also be provided using communication means. In that case, for example, the program explained above may also be considered as an invention that is a “computer readable recording medium storing a program”.

The “computer readable recording medium storing a program” is a computer readable recording medium used for installation, execution, and distribution of the program and in which the program is stored.

Note that examples of the recording medium include a digital versatile disc (DVD), a compact disc (CD), a Blu-ray disc (Blu-ray® Disc), a magneto-optical disk (MO), a flexible disk (FD), a magnetic tape, a hard disk, a read-only memory (ROM), an electrically erasable programmable ROM (EEPROM), a flash memory, a random access memory (RAM), an SD (Secure Digital) memory card, and the like. DVDs include “a DVD-R, a DVD-RW, a DVD-RAM, and the like” for standards developed by the DVD forum and “a DVD+R, a DVD+RW, and the like” for standards developed by DVD+RW. CDs include a compact disc-read-only memory (CD-ROM), a CD recordable (CD-R), a CD-Rewritable (CD-RW), and the like.

The above-described program or a portion of the program may be stored and saved in the above-described recording medium, distributed, or the like. The above-described program or a portion of the program may be transmitted by communication, for example, through a wired network, a wireless communication network, or a transmission medium such as a combination of a wired network and a wireless communication network or the like used in, for example, a local-area network (LAN), a Metropolitan Area Network (MAN), a wide area network (WAN), the Internet, an intranet, an extranet, and the like. Alternatively, the above-described program or a portion of the program may also be transferred by a carrier wave.

Furthermore, the above-described program may be a portion of another program or may also be stored in a recording medium together with a separate program. In addition, the above-described program may also be divided and stored in plural recording mediums. In addition, the above-described program may be stored in any format such as a compressed format, an encrypted format, or the like, as long as the above-described program may be reconstructed.

1. An information processing apparatus comprising:
a first calculation unit that calculates an amount of information on an answer, which is an amount of information on a receptionist's answer to a question from a questioner;
a second calculation unit that calculates an amount of acquired information, which is an amount of information acquired by the receptionist to make the answer;
a difficulty-level estimation unit that estimates a difficulty level of the question in accordance with a total amount of information necessary for the answer to the question; and
an estimation unit that estimates the receptionist's specialty in accordance with the amount of information on the answer, the amount of acquired information and the difficulty level.

2. The information processing apparatus according to claim 1, further comprising:
an assignment unit that assigns a receptionist to the question in accordance with the specialty.

3. The information processing apparatus according to claim 1,
wherein the acquired information in the second calculation unit includes an answer to a question addressed to another receptionist.

4. The information processing apparatus according to claim 2,
wherein the acquired information in the second calculation unit includes an answer to a question addressed to another receptionist.

5. The information processing apparatus according to claim 3,
wherein the acquired information in the second calculation unit further includes at least one of the question from the questioner and the question addressed to the other receptionist.

6. The information processing apparatus according to claim 4,
wherein the acquired information in the second calculation unit further includes at least one of the question from the questioner and the question addressed to the other receptionist.

7. A recording medium storing a program for causing a computer to function as:
a first calculation unit that calculates an amount of information on an answer, which is an amount of information on a receptionist's answer to a question from a questioner;
a second calculation unit that calculates an amount of acquired information, which is an amount of information acquired by the receptionist to make the answer;
a difficulty-level estimation unit that estimates a difficulty level of the question in accordance with a total amount of information necessary for the answer to the question; and
an estimation unit that estimates the receptionist's specialty in accordance with the amount of information on the answer, the amount of acquired information and the difficulty level.

8. An information processing method comprising:
calculating an amount of information on an answer, which is an amount of information on a receptionist's answer to a question from a questioner;
calculating an amount of acquired information, which is an amount of information acquired by the receptionist to make the answer;
estimating a difficulty level of the question in accordance with a total amount of information necessary for the answer to the question; and
estimating the receptionist's specialty in accordance with the amount of information on the answer, the amount of acquired information and the difficulty level.
